(19) United States
(12) Patent Application Publication
(10) Pub. No.: US 2005/0251393 A1
(43) Pub. Date: Nov. 10, 2005

(54) Arrangement and a method relating to access to internet content

(76) Inventor: Sorin Georgescu, Montreal (CA)

Correspondence Address: ERICSSON INC., 6300 LEGACY DRIVE, M/S EVR C11, PLANO, TX, 75024, US

(21) Appl. No.: 10/519,640

(22) PCT Filed: Jan. 16, 2003
(86) PCT No.: PCT/SE03/00058

§ 371 Date: Dec. 28, 2004

(30) Foreign Application Priority Data
Jul. 2, 2002 (SE) 0202058-4

(51) Int. Cl. G10L 21/00

(52) U.S. Cl. 704/270.1

(57) ABSTRACT

The present invention relates to an arrangement (and a method) allowing multi-modal access of content over a global data communications network, e.g. Internet, comprising a mobile station (1), with a user agent, a proxy server (2), and a telephony platform (3). The mobile station (1) is a dual mode station supporting concurrent voice and data sessions, the proxy server (2) comprises an enhanced functionality for supporting voice browsing, and the telephony platform (3) comprises an Automatic Speech Recognizer (ASR) (31) and a block for converting text messages to speech. Said enhanced proxy server (2) interfaces the Automatic Speech Recognizer (31) of the Telephony Platform (3), and key elements (e.g. text, words phrases) are predefined and indicated in the (original) web content. When the enhanced proxy server (2) recognizes/extracts said key elements (using predefined rules) it triggers voice browsing, such that an arbitrary web content (page) can be accessed by voice commands without requiring conversion of the web content.

### TECHNICAL FIELD

The present invention relates to an arrangement allowing multi-modal access to e.g. Internet content over Internet, which comprises a mobile station, with a user agent, a proxy server and a telephony platform. The invention also relates to a method for enabling multi-modal access to e.g. Internet content.

### STATE OF THE ART

Multi-modal browsing is a user friendly method for accessing content over a global data communication network, e.g. Internet. For accessing content using a multi-modal browser, a user should be able to use any supported input method or a combination thereof. Today known input methods are the key method, the mouse click method and the voice command method, although also other input methods could be implemented. However, so far no known architecture is capable of adding voice browsing functionality to an ordinary user agent running in a dual mode voice and data mobile station. Instead, existing voice browsing systems are based on VoiceXML, extensible markup language, which is a language capable of defining voice dialogs. In such a VoiceXML system, two browsers are required and the voice browsing application (the speech browser) runs independently of the keypad based browsing application. There is no synchronisation between the two different browsers. In addition thereto, it is not possible to implement multi-modal browsing unless the content has been designed for both the conventional HTML/XHTML format and VoiceXML. Content designed for two different formats is thus a requirement.

Voice browsing is thus presently implemented based on VoiceXML, which is a language for defining voice dialogs for Internet applications accessed over phone. Output voice dialogs are essentially carried out through audio and text-to-speech prompts, whereas input dialogs are carried out through touch-tone keys (DTMF) and automatic speech recognition. A known and typical architecture consists of an application server hosting VoiceXML content, a VoiceXML gateway containing the speech browser (a VoiceXML client) and the speech/telephony platform. The user system interaction is performed through a voice menu from which the user can specify his selection by voice. All functionality regarding speech recognition, text-to-speech conversion, and DTMF (Dual Tone Multi Frequency) recognition is implemented in the speech/telephony platform, which converts the dialogs specified in the VoiceXML page to/from speech. It is the speech browser, based on the content interpreted on-the-fly, that controls the sequence of voice dialogs. It should be pointed out that only the voice part of the mobile station is used during user interaction. Using such a system, multi-modal access to Internet applications is only possible if both HTML/XHTML and Voice/XML formats are available on the application server. The mobile station further has to be a dual mode voice and data station in order to be able to establish simultaneous voice and data sessions.

It is however a problem that, with known architectures for voice-based applications, voice dialogs usually have to be defined in VoiceXML. This has as a consequence that only application/content which is specifically designed for voice-based interaction may be accessed over the phone. Most HTML/XHTML content will thus never be possible to access by voice, unless it is first converted into VoiceXML.

It is also a problem with known systems or architectures that, when voice-based access is combined with normal browsing, for the purpose of implementing multi-modal browsing, there is no mechanism for synchronisation of the two browsers, for example the HTML/XHTML browser running in the data part of the mobile station and the speech browser running in the VoiceXML gateway. Therefore it is not possible to switch from one input method to another during one and the same browsing session, unless a dedicated synchronisation mechanism is implemented in the application server, the speech browser and the user agent of the mobile station.

There is for example one architecture known which is denoted SALT (Speech Application Language Tags, Microsoft), which comprises a small set of XML elements (listen, prompt, DTMF) which after having been added to an original HTML/XHTML page, provide a speech interface to the content. In order to interpret these new tags, a SALT voice browser or a SALT multi-modal browser is required. However, it is not specified in which node HTML/XHTML content and SALT tags are merged. This architecture either requires a SALT multi-modal browser, or in case access is provided through simple telephones, a telephony server that interprets the SALT scripts in the accessed page. For content management, either the content providers modify original content to includes SALT tags, or a proxy could be provided that comprises this functionality. In both cases there is a risk that browsers that do not support SALT might crash when trying to interpret SALT tags. Since the storing capability is limited in wireless browsers, it is in general difficult to deal with new XML tags. As can be seen it is apparently disadvantageous to introduce new tags into the content. The SALT architecture is also a complex structure, and if the content is not already SALT compliant, a SALT proxy is required to add SALT tags in addition to the telephony server implementing the opposite functionality, e.g. of converting SALT tags into speech. If a SALT browser is used, this will perform the reverse conversion. Therefore, in order to understand SALT tags, the SALT browser must contain or communicate with a speech recognition and text to speech system. To develop such a functionality on a terminal is in principle very difficult and this means that remote systems have to be used. This problem has however not been addressed in the proposal of the SALT architecture. To summarize, the SALT architecture is too difficult to implement, and it will be too complex and inefficient for use on large scale.

### SUMMARY OF THE INVENTION

It is therefore an object of the present invention to provide an arrangement, through which multi-modal access to content is enabled in a manner which is not complex, and which is convenient for implementation on large scale. It is also an object of the invention to provide an arrangement through which the original content to be accessed does not have to be affected, as well as an arrangement through which any tag based content, e.g. a large amount of HTML/XHTML web content can be accessed without requiring the content being converted into, for example, VoiceXML, or without the content having to be provided with new tags. Further yet it is an object of the invention to provide an arrangement, through which an existing infrastructure can be used, i.e. that in principle any browser can be used as well as any dual mode mobile station, while still allowing multi-modal access. It is also an object of the invention to provide an arrangement through which multi-modal access of content can be provided without requiring any changes in the interface to the browser. Particularly it is an object to provide an arrangement through which web content can be accessed either via voice based access or via conventional access, irrespectively of which format the content is available in. Specifically it is an object of the invention to provide an arrangement through which synchronisation can be provided between a conventional browser in the user agent and a voice browser.

It is also an object of the invention to provide method for multi-modal access of content through which one or more of the above mentioned objects can be fulfilled.

Therefore an arrangement having the characterizing features of claim 1 is provided. Furthermore methods having the features of claims 26 and 27 are provided.

Advantageous or preferred embodiments are given by the appended sub-claims.

It is an advantage of the invention that any web content can be accessed either by voice browsing or by conventional browsing irrespectively of in which format the content is provided, and without having to convert any content or provide it with tags etc. It is also an advantage that already existing equipment can be used to implement the inventive concept. A further advantage consists in that the service provider does not have to provide for two kinds of tagging or re-tagging.

### BRIEF DESCRIPTION OF THE DRAWINGS

The invention will in the following be further described, in a non-limiting way, and with reference to the accompanying drawings, in which:

FIG. 1 is a schematical block diagram of an arrangement according to the invention,

FIG. 2 is a block diagram as in FIG. 1 describing the procedure in a detailed manner according to one embodiment,

FIG. 3 is a simplified block diagram of an enhanced proxy server including voice browsing functionality according to the invention,

FIG. 4 is a general flow diagram describing the procedure according to the invention,

FIG. 5 is a flow diagram describing the procedure more in detail when voice browsing is used for access of web content with an arrangement according to the invention, and

FIG. 6 is a flow diagram schematically describing one embodiment of the synchronisation procedure between ordinary browsing and voice browsing.

### DETAILED DESCRIPTION OF THE INVENTION

The invention suggests an arrangement, including selection of speech vocabulary keywords or elements to enable access to an arbitrary, e.g. HTML/XHTML page, or content of a global data communication system in general, by means of voice commands, through which multi-modal browsing is enabled without requiring any changes in the original content.

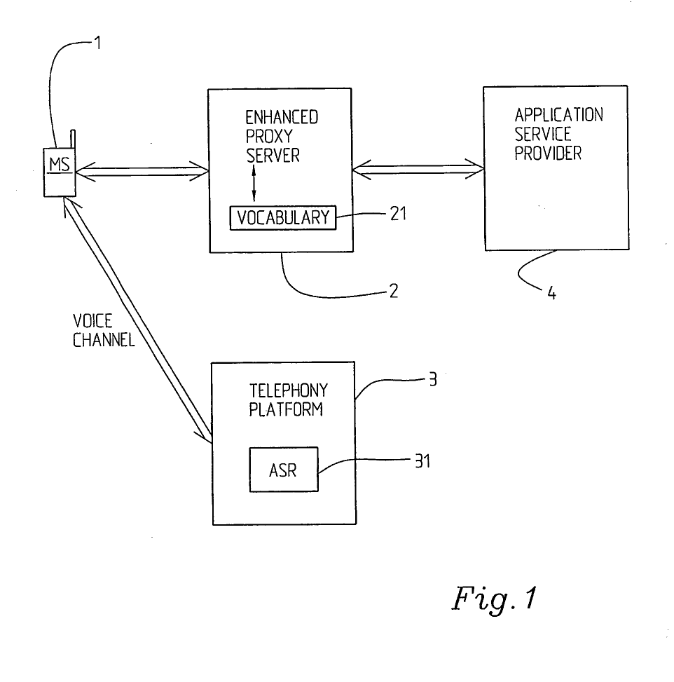

FIG. 1 schematically illustrates an arrangement according to the invention which comprises a dual mode mobile station 1 supporting simultaneous communication of voice and data and which comprises a user agent as is known per se. Furthermore the arrangement comprises a proxy server with an enhanced functionality, consisting in that the proxy server 2 is speech enabled, enhanced with a voice browsing functionality. It is capable of extracting keywords from browsed web content in any format, e.g. HTML/XHTML, governed by predefined rules. Vocabulary of keywords is stored in vocabulary storing means 21 in the enhanced proxy server 2. The keywords are emphasized or in some way indicated, e.g. highlighted in the original content, such that the end user of the mobile station 1 will know what key elements, or keywords to use in speech commands for selecting a specific hyperlink. The enhanced proxy server 2 interfaces to a telephony platform 3 containing an automatic speech recognizer (ASR) 31. Due to the keyword spotting nature of the browsing functionality, the automatic speech recognizer 31 can with advantage be a medium size vocabulary speech recogniser. Such an ASR 31 is generally capable of recognising continuous speaker independent speech. This is an advantage, since then no user training is required to setup a system of the suggested architecture.

The mobile station 1 must support concurrent voice and data sessions. Via the enhanced proxy server 2, content as provided by the application service provider (ASP) 4 can be accessed.

The telephony platform 3 comprises as well a Text-To-Speech (TTS) block. During the speech interaction, the enhanced proxy server 2 uses speech dialogs/prompts whenever received commands are ambiguous. Standard text messages are forwarded to the TTS block in the telephony platform 3. The TTS blocks converts the messages to speech dialogues which are then sent to the end user over a voice channel the establishment of which will be more thoroughly described below. The proxy server 2 parses the content fetched from the Application Service Provider ASP 4 and analyses paragraphs in the accessed page using some kind of an analyser, e.g. syntactic analyser, as will be referred to below, to find meaningful key elements or keywords.

As referred to above, the Text-To-Speech (TTS) block in the telephony platform 3 converts the text messages to speech dialogues which are then sent to the end user over an established voice channel. Speech dialogs might for example look like “Did you select the paragraph containing keyword X?”.

As referred to above, different kinds of rules can be predefined and used to extract the key elements or keywords. Preferably adaptive keyword extraction is implemented. In one embodiment, so called syntactic rules are used. Examples thereon are rules like “use the subject and the predicate in a paragraph associated with a single hyperlink”. Several syntactic rules prioritised with regard to the availability of keywords in the vocabulary may be implemented.

Another example on predefined rules may relate to simple rules, for example like “select a unique keyword in the hyperlink name, or in the paragraph associated with it”. Speech commands associated with a simple rule may be “Go to X” or “Go to the paragraph containing X”.

In still another implementation, numerical rules are used. This refers to a numbering of hyperlinks in the content or in the page, or multiple hyperlinks in one and the same paragraph. This method can also be used for selection of option in menus. It is generally a minimum requirement that at least recognition of numbering should be supported by the vocabulary.

Thus, first communication is established between the enhanced proxy server 2 and the telephony platform 3 with the automatic speech recogniser 31 for application/vocabulary to bind to. In other words a request for connection of two nodes is sent from the enhanced proxy server 2 to the telephony platform 3 requesting it to specify the relevant vocabulary, which then is provided to the enhanced proxy server 2. Then a subscriber, i.e. the end user of the mobile station 1, may open a normal browsing session. The enhanced proxy server 2 comprises for each subscriber a subscriber record.

In order to trigger voice browsing functionality, there should be a means to indicate if the feature should be activated or not. This might be a keyword for triggering voice browsing, or a hyperlink inserted in the accessed web page, which upon selection triggers the opening of a voice channel between the mobile station 1 and the ASR 31 of the telephony platform 3. The request from the end user is forwarded to the ASP 4. (This is done irrespectively of whether voice browsing is on or not). The ASP 4 then sends back the accessed page to the enhanced proxy server which parses the content and analyses paragraphs according to any of the above mentioned methods relating to rules for extracting keywords. The found keywords are then emphasized in any appropriate manner by the enhanced proxy server 2. For the concerned browsing session, an ID is stored as well as subscriber MSISDN and selected keywords. The modified page or content is then sent to the MS 1. Thereupon a voice browsing session is opened with the ASR 31. The voice channel is thus opened concurrently with the data session channel. The ASR 31 will then forward the keywords recognized in the users voice commands to the enhanced proxy server 2. The keywords are analysed in the enhanced proxy server and matched to the ones selected above when parsing the content from the accessed page. If there was a match, the link as obtained in the preceding step is used by the proxy when sending a GET request to the ASP 4.

Generally, when implementing multi-modal browsing, it is required that a synchronisation engine is provided between the HTTP browser in the user agent and the speech browser, residing besides the voice browsing functionality. Since the enhanced proxy server 2 automatically extracts keywords from content pages, there is no need to develop special voice tags for the HTML/XHTML content. Furthermore, due to the push mechanism used to force a refresh of the content after some hyperlink has been identified using voice commands, multi-modal user input will be in synchronization.

As far as the vocabulary recognized by the ASR is concerned, a middle size vocabulary adjusted to the most frequently used words in the recognized language of about 2000-3000 words will probably be good enough, even if the invention is not limited to that. Standard speech queries/prompts on less suggestive keywords in the paragraphs can be used in case the most suitable keywords are not part of the recognized vocabulary. VoiceXML may for example be an option to define such speech queries/prompts. The enhanced proxy server contains a push mechanism forcing the user agent in the MS to refresh the content, when having fetched the page indicated through voice commands. In one implementation this could be based on a semaphore object (refresh on/off), which will be thoroughly explained later on in the description, inserted in each returned page, and a script downloaded together with the page. The script forces periodic updates of the semaphore value, thus allowing the user agent to detect when a page refresh is requested by the enhanced proxy server. Based on the semaphore's value, the script may then trigger refreshing of an entire page, thus downloading the new content.

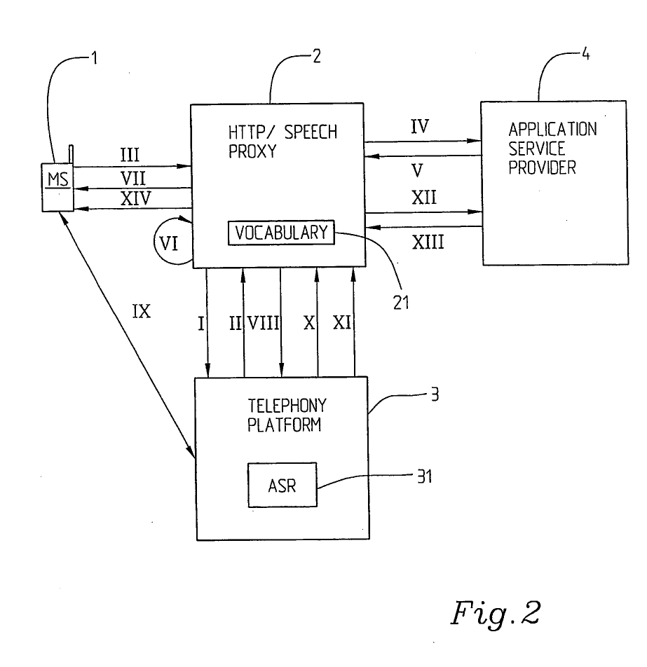

FIG. 2 is a block diagram similar to that of FIG. 1 but explicitely indicating and explaining the different steps according to one particular embodiment. Signal I relates to the enhanced proxy server connecting to the telephony platform 3 with ASR 31, requesting the telephony platform 3 with the ASR 31 to specify the application/vocabulary for recognition. This is very advantageous when an ASR hosts several applications implementing variations of the user/system speech interface, e.g. the specific sequence of voice prompts, allowed key strokes, vocabularies etc.

The ASR 31 then returns a reply, II, with words contained in the vocabulary and specifying the features supported by the telephony platform 3, such as call-back activated, number of voice ports etc. Advantageously an ID of the invoked application is returned as well. The subscriber then opens a normal browsing session, III. In order to support voice browsing, particular information needs to be stored into the subscriber record in the enhanced proxy server 2. Such information comprises an indication as to whether voice browsing is on/off, an optional keyword for triggering voice browsing, an optional hyperlink name to be inserted in the web-page or web content accessed, which, when selected, triggers opening of a voice channel between the ASR of the telephony platform 3 and the mobile station 1.

When the subscriber opens a normal browsing session, this results in sending a HTTP request to the enhanced proxy server 2. The enhanced proxy server 2 then authenticates the user and checks if voice browsing is on (see above). Thereupon the HTTP request is forwarded to the Application Service Provider ASP 4, IV. If voice browsing is activated, or on, the proxy server chooses a method to open the voice channel referred to above, particularly based on user profile. This can be done in different ways, either automatically (corresponding to steps VIII, IX below) or triggered in that the user selects a particular HTTP link during browsing. This is not illustrated or further explained herein, but it is likewise covered by the inventive concept.

ASP 4 then sends back the HTML/XHTML page to which access was requested, V, to the enhanced proxy server 2. The enhanced proxy server then, in step VI, parses the received content and analyses paragraphs in the content or web page using for example a syntactic analyser to find meaningful keywords. Of course also other analysis methods can be used as referred to above. Alternatively words in a hyperlink name may be selected as keywords. However, selected keywords have to be part of the downloaded vocabulary and should not imply very close or similar voice commands. The keywords are then emphasized, e.g. highlighted, in the page. This can be done in different ways, for example by underscoring. A keyword may be present in several multi-word voice commands on condition that there is enough discriminating information between the commands, i.e. they may not be too similar. For each browsing session, the ID of the voice browsing session, the MSISDN of the subscriber and selected keywords should be stored in the enhanced proxy server 2. The modified content or page is then sent by the enhanced proxy server 2 to the mobile station 1, VII.

A voice browsing session is then opened with the ASR 31 for the authenticated user, VIII. The request should include the voice browsing session ID, the end user MSISDN and the application ID (if this was provided in step II above). The telephony platform 3 performs a call to the mobile station 1 using the specified MSISDN. A voice channel is opened between the ASR and the MS 1 concurrently with the data session channel, IX. This corresponds to the automatic opening of the voice channel as discussed above in step IV. As referred to above, the voice channel could also be switched on and off manually, through user selection of a special hyperlink. In still another implementation, if the mobile station uses Voice overIP for voice services, the voice browsing proxy may use only the data channel and there is thus no need for opening a specific voice channel. This will however not be further discussed herein but relates to a particular embodiment.

After the voice channel has been opened, i.e. the call is answered by the user, the ASR 31 returns the status data to the enhanced proxy server 2, X. Moreover, the ASR 31 forwards the keywords recognised in the voice commands given by the end user to the proxy, XI. Particularly each keyword is accompanied by its recognition probability. The enhanced proxy server 2 analyses the keywords and tries to match them to the ones selected in step VI above. If several highlighted keywords correspond to a certain degree of confidence in relation to the keywords recognised in the command, or if voice confirmation is activated, the enhanced proxy server 2 will send a text to playback to the ASR 31 in the telephony platform 3. Based on the replies from the end user, the enhanced proxy server 2 will later on decide which link should be used. For reasons of simplicity voice prompting is not illustrated in the diagram. When thus a link has been found, the enhanced proxy server 2 uses said link to send a GET request to the ASP 4, XII. A reply, XIII, is then provided to the enhanced proxy server 2, and when the reply has been received, the content is processed by the enhanced proxy server 2 as explained above with reference to step XI. Subsequently the enhanced proxy server 2 pushes the page to the user agent of the mobile station 1.

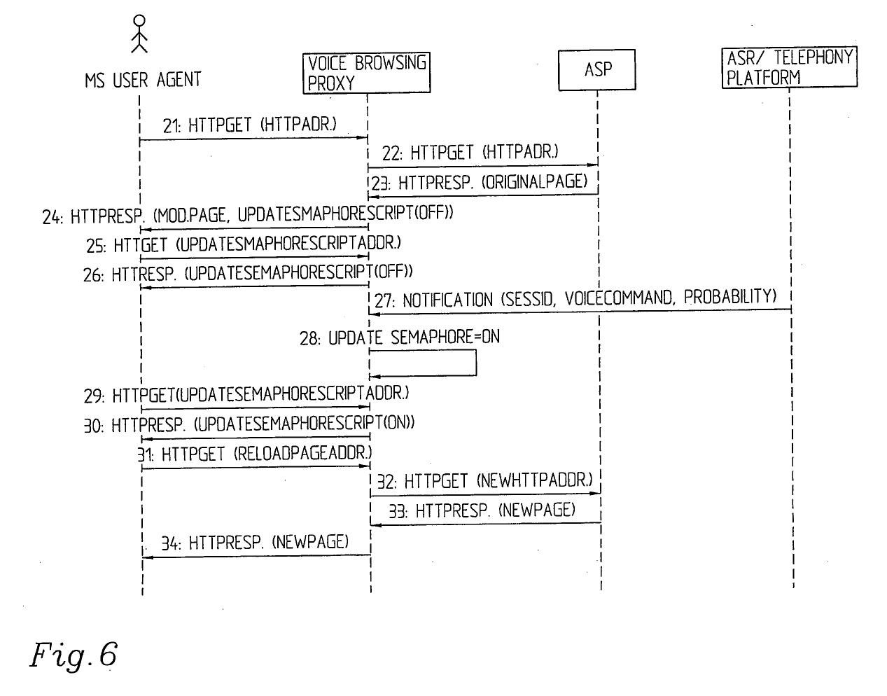

The suggested voice browsing architecture and selection of keywords solve in a natural way the issues of synchronisation between the user agent of the mobile station and the voice browser. Therefore, since the enhanced proxy server automatically extracts keywords from received and examined content pages, there is no need to develop a special voice format for the HTML/XHTML content. In addition thereto, due to the push mechanism used to force a refresh of the content after some hyperlink has been identified using voice commands, multi-modal user input will always be in synchronisation. An advantageous way to provide synchronisation is based on semaphore objects. The push mechanism used to force a content refresh etc. will be further described below with reference to FIG. 6.

According to the present invention no new tags are added into the content. The only modification done to the content by the enhanced proxy server consists in changing tag attributes, e.g. color, such that a user will know what keyword to use when browsing. As a consequence thereof, there is no risk that existing browsers crash. In principle any browser could be used. Furthermore, since there is nothing new, i.e. no new tags in the content or in the web-page, the browsing experience will be uneffected. Instead of clicking on a link, the user uses natural language commands for selecting the keyword associated to the link. Due to the keyword spotting functionality, the user can use any natural sequence of words containing the keyword. Actually it is the enhanced voice browsing proxy server that selects the keywords and makes them visible to the end user through emphasizing them in one way or another, i.e. through highlighting, underscoring or similar. Nothing changes in the interface to the browser, it still is HTML/XHMTL (if these markup languages are used). In addition thereto it is not the multi-modal mobile station that has to contact a remote speech recogniser. A mobile station will not receive any speech tags. Instead, it is the enhanced proxy server that contacts the remote speech recogniser ASR. This means that no new interface needs to be developed from the terminal to the ARS, or in the worst case developed in the terminal. This also means that all existing dual mode terminals can be used without modification. According to the invention, and as explained above, a rule based philosophy is used to select keywords which means that content transformation can be performed automatically by the enhanced proxy server. This is possible since existing links in the content are used for that purpose. Words inside the link name, or inside a paragraph associated with a link are selected as keywords by the enhanced proxy server which is a simple solution. However, of course more complex rules can be used. This means that a dynamic selection of keywords is enabled due to the keyword spotting mechanism.

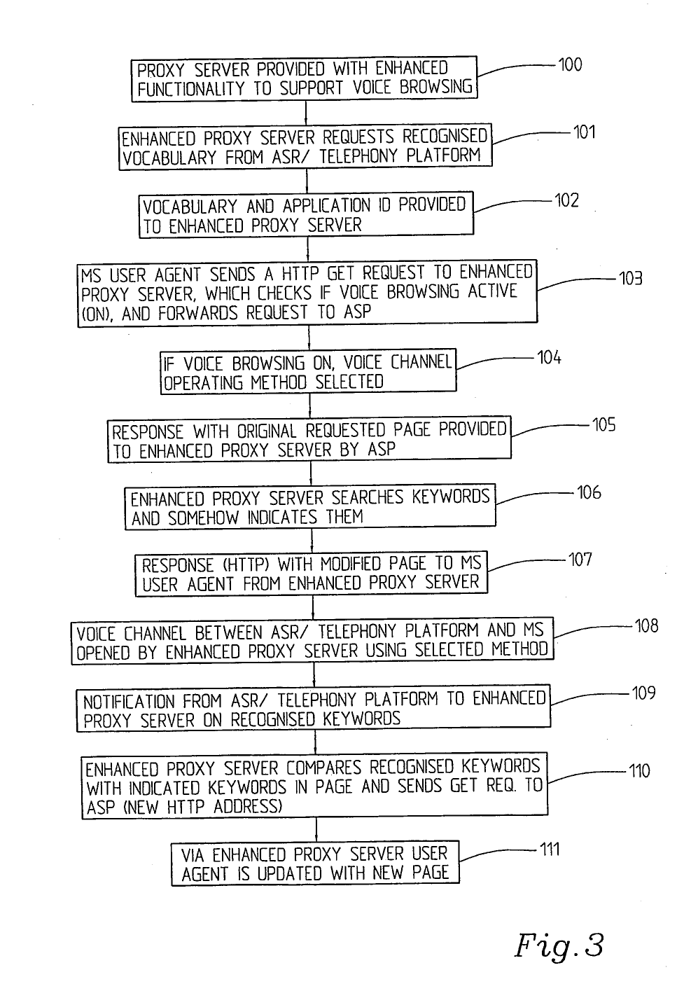

FIG. 3 shows, in a somewhat generalized manner, the procedural steps according to one particular embodiment. It is first supposed that a proxy server, in principle any appropriate proxy server with conventional browsing functionality, is provided with an enhanced functionality such as to also support voice browsing, 100. The enhanced proxy server then sends a query to a telephony platform with an ASR for a specification of vocabulary, 101. The relevant vocabulary, and preferably also an application ID for the concerned application is then retrieved from the telephony platform/ASR to the enhanced proxy server, 102.

Subsequently, as the MS user agent sends a GET request (e.g. HTTP) to the enhanced proxy server, it is checked (in the server) if voice browsing is active (ON), if yes, the request is forwarded to the ASP, 103. (Also for a conventional request (i.e. not voice browsing) the request is of course forwarded to ASP, but this is known per se.) If voice browsing is active (on), the proxy server selects an appropriate method for opening a voice channel, 104. ASP sends a response to the enhanced proxy server with the original, requested page, 105. The enhanced proxy server then searches for keywords. If such are found, they are indicated in an appropriate manner, e.g. highlighted etc., 106. Thereupon the enhanced proxy server sends a response (HTTP) with the page modified as described above (highlighted keywords or similar) to the MS user agent, 107.

By means of the selected voice channel opening method a voice channel is opened, by the enhanced proxy server, between the ASR/Telephony platform and the MS, 108. The ASR/Telephony platform sends a notification to the enhanced proxy server relating to keywords recognised in the speech stream from the end user, 109. The enhanced proxy server then compares the recognized keywords with the keywords somehow indicated in the modified page and sends a GET request to the ASP, for the new HTTP address, 110. Finally the MS user agent is updated with the new page via the enhanced proxy server, 111.

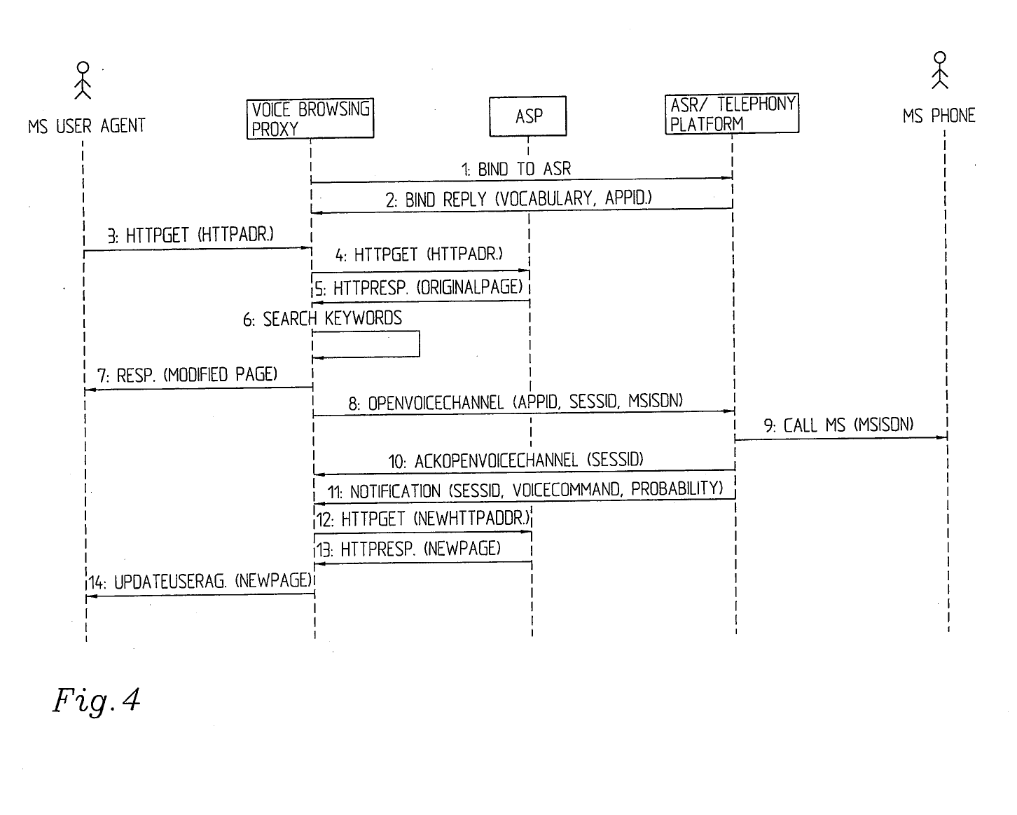

The same procedure is illustrated in a somewhat more detailed manner with reference to the sequence diagram of FIG. 4. (Reference is also made to the block diagram of FIG. 2.) The enhanced proxy server (also called voice browsing proxy) sends a Bind Request to the ASR/Telephony platform (i.e. it queries for recognized vocabulary), 1. ASR/Telephony platform returns a Bind Reply with vocabulary and application ID to the voice browsing proxy, 2. MS user agent (here) sends a HTTP GET request (http Address) to the voice browsing proxy, 3, which forwards the HttpGet (http Address) to the ASP, 4. If voice browsing is ON, a voice channel activation method is retrieved. ASP provides a HttpResponse (the original page) to the voice browsing proxy, 5.

The voice browsing proxy then searches for keywords, 6, and highlights or underscores them. Of course also some other method can be used to indicate keywords. The page hence modified is then provided in a HTTP Response to the MS user agent, 7. A voice channel is then opened by the voice browsing proxy regarding the relevant application ID, session ID and MSISDN (for the MS) through the request sent to ASR/Telephony platform, 8. The ASR/Telephony platform then performs a call to the MS telephone with specified MSISDN, step 9, and acknowledges that the voice channel is opened for the given session ID, to the voice browsing proxy, 10, i.e. status data. ASR also notifies, in a notification containing session ID, voice command, and probability, the proxy on recognised keywords, 11. (The call has been answered by the user.) Preferably each keyword is accompanied by the respective probability of recognition.

The voice browsing proxy tries to match, or compare, recognized keywords with/to e.g. highlighted keywords in the page. If there is a mismatch, voice prompting may be used. It is supposed that a link is found by the voice browsing proxy, and, using this link, the voice browsing proxy sends a GET Request (HttpGet(new Http Address)) to ASP, 12. After reception of the response (HttpResponse (newPage)) from the ASP, 13, the content is processed, and the MS user agent is updated with the new page, which thus is pushed to the MS user agent, 14. Thereby synchronisation is obtained as will be more thoroughly described with reference to FIG. 6.

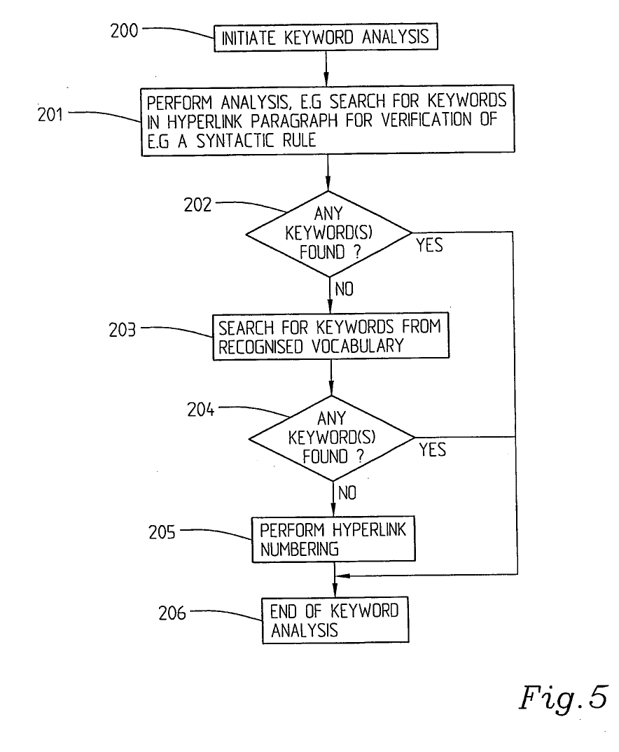

FIG. 5 is a schematical illustration of a keyword selection mechanism according to one embodiment of the invention implementing the keyword analysis. First, it is settled that a keyword analysis is to be initiated, 200. Here the analysis is performed through searching for keywords in a hyperlink paragraph for verification of the relevant syntactic rule, 201. Then it is established if any keyword(s) is/are found, 202. If not, a vocabulary keyword lookup is carried out, 203, i.e. a search is performed to find keywords from the recognised vocabulary. If keyword(s) on the other hand is/are found, the keyword analysis is completed, 206, i.e. both if keywords are found in step 202 or in step 203.

If, however, also the result of the keyword lookup is negative, a hyperlink numbering is performed, 205. This means that numbers are assigned to hyperlinks or text paragraphs. Then the keyword analysis is ended.

FIG. 6 gives an example of a synchronisation mechanism that can be used according to one implementation of the invention. It relates to a synchronisation mechanism between the MS user agent and the enhanced proxy server (also denoted voice browsing proxy). First the MS user agent sends a GET Request, to the voice browsing proxy, 21. The proxy forwards the request to the ASP, 22. ASP in turn responds with the original page to the voice browsing proxy, 23. A timer element is then introduced into the page to control script reload, and the proxy sends a response with the modified page, update semaphore (OFF) to the MS user agent, 24. At expiry of the timer (timeout), the MS user agent sends a GET Request specifying the update of the semaphore script address, to the proxy, 25.

The voice browsing proxy sends a response to the MS user agent with update semaphore script (OFF), 26. The ASR/Telephony platform then sends a notification to the proxy with session ID, voice command and preferably probability, 27. The address of the new page is determined through matching the voice command (cf. FIG. 4) to one of the indicated (e.g. highlighted) keywords. In the voice browsing proxy the semaphore is set ON by a script whenever a voice command is recognised, 28. At timeout, i.e. expiry of the time, the MS user agent sends a GET Request to the voice browsing proxy specifying the update of the semaphore script address, 29. A response is returned by the voice browsing proxy to the MS user agent with update semaphore script (ON), 30. The MS user agent then sends a GET Request (reload page address) to the voice browsing proxy, 31. The proxy recognises the reload page address argument and replaces it with the address of the voice browsed page. The proxy sends a GET Request to the ASP, 32, for the new address. The response with the new page is provided from ASP to the proxy, 33, which forwards it to the MS user agent, 34.

Thus, in this implementation the synchronisation mechanism between user agent in the MS and voice browsing proxy, is based on a semaphore object (Client Semaphore) inserted into the original XHTML content, by the voice browsing proxy. The original copy of the semaphore (Proxy Semaphore), is stored in the proxy, and is set ON at the time voice browsed content needs to be “pushed” towards MS. Synchronisation is achieved through periodic updates of the Client Semaphore, with the value of the Proxy Semaphore. Very little bandwidth is required to update one object in a page, instead of full content. On the client side, the Client Semaphore is continuously checked on by a script downloaded together with the originally loaded XHTML page, to find out whether page/card GET has been ordered by the proxy. This GET Request from the client side represents, in fact, the means to simulate proxy “Push” of voice browsed content. On the proxy side, the Proxy Semaphore is set ON by a script whenever voice commands are recognised. Proxy Semaphore reset may occur after the Client Semaphore has been updated.

Since the XML languages do not support the Semaphore element type, a language specific paradigm should be used. In the following, it is referred to WML (Wireless Markup Language) 2.0 specification. WMLScript Standard Libraries are used as well to implement the proposed functionality.

The Client Semaphore is modeled by means of a WML script variable. This script is retrieved from the proxy, and its main task is to trigger the HTTP GET method that fetches voice browsed page/card. The proxy stores two versions of the script. One where the semaphore is set “ON”, and another where the semaphore is set “OFF”. However, only the copy that reflects Proxy Semaphore status will be placed in the URL directory where the client looks for the script. Below a possible implementation of the script is illustrated:

extern function updateSemaphore( )
{

var semaphore = “semaphoreValue”;
if (semaphore = “ON”)
{

var url = “http://browsingProxy.ericsson.se/wml/getPage.wml”;
WMLBrowser.go (url);

}

}

Periodic invocation of updateSemaphore script is achieved by using a timer element inserted by the proxy, into the original WML page/card. Upon time expiry, the binary script will be fetched from the proxy, and executed. Should the semaphore be set on, a HTTP GET is issued. to fetch the voice browsed page/card. The proxy will re-map the URL in client's request to the one resulting from voice command interpretation, and issue a HTTP GET to the ASP. Voice browsed content can thus be downloaded to the User Agent, without any user intervention. The semaphore may be called from a WML card as follows:

<card>

<onevent type=“timer”>

<go href=“http://browsingProxy.ericsson.se/scripts/semaphore.
wml/s#updateSemaphore( ) ”/>

</onevent>

</card>

1-27. (canceled)

28. A system for allowing multi-modal access of content over a global data communications network using a mobile station (MS) with a user agent, a proxy server, and a telephony platform, wherein:
said mobile station is a dual mode station supporting concurrent voice and data sessions;
said proxy server comprises an enhanced functionality for supporting voice browsing;
said telephony platform comprises an Automatic Speech Recognizer (ASR) and is operative to convert text messages to speech;
key elements are predefined and indicated in the original web content; and
when the proxy server recognizes/extracts said key elements, using predefined rules, it triggers voice browsing, such that arbitrary web content can be accessed by voice commands without requiring conversion of the web content.

29. The system according to claim 28, wherein multi-modal browsing is implemented.

30. The system according to claim 28, wherein the proxy server parses an accessed web content with regard to said key elements.

31. The system according to claim 28, wherein the accessed web content is browsed by means of key strokes or mouse clicks.

32. The system according to claim 28, wherein said system allows for voice-based access of any tag based content.

33. The system according to claim 28, wherein the user of the mobile station uses a key element indicated in the web content to select a specific hyperlink.

34. The system according claim 28, wherein the voice browsing functionality of the proxy server implements keyword spotting.

35. The system according to claim 28, wherein the proxy server interfaces with the Automatic Speech Recognizer which comprises a medium size vocabulary speech recognizer.

36. The system according to claim 28, wherein the predefined rules for voice key element extraction are syntactic rules.

37. The system according to claim 28, wherein the predefined rules for voice key element extractions are simple rules relating to selection of a unique keyword in the name of a hyperlink.

38. The system according to claim 28, wherein the predefined rules for voice key element extraction are numeric rules numbering hyperlinks in said web content.

39. The system according to claim 28, wherein the proxy server forwards text prompts to a text-to-speech function in the telephony platform, wherein the text messages are converted to speech and forwarded to the user over the voice channel set up by the proxy server.

40. The system according to claim 28, wherein between the conventional browser in the user agent and the speech browser in the proxy server a synchronization engine is provided.

41. The system according to claim 40, wherein the proxy server comprises a pushing mechanism for making the MS user agent refresh indicated, fetched content.

42. The system according to claim 41, wherein a semaphore object is introduced into the content returned to the proxy server for indicating activation or not of content refresh.

43. The system according to claim 28, wherein a connection is established between the proxy server and the Automatic Speech Recognizer of the telephony platform for specifying and identifying a called application to be accessed.

44. The system according to claim 43, wherein the proxy server comprises a number of subscriber records, and in that for each subscriber for which voice browsing should be supported, means for indication of voice browsing activation, optional key element for triggering voice browsing or optional hyperlink name, for insertion in accessed web content, and which, when selected, provides for establishment of a voice channel between the ASR and the mobile station.

45. The system according to claim 43, wherein if voice browsing is activated, the access request is forwarded from the proxy server to the relevant Application Service Provider, which returns the requested content to the proxy server, and in that said proxy server comprises parsing and analyzing means for finding and indicating key elements, before forwarding the content as modified to the mobile station.

46. The system according to claim 28, wherein a request for voice browsing includes at least a voice browsing session ID and MSISDN of the user station.

47. The system according to claim 46, wherein for a user authenticated by the proxy server, a voice channel is established, concurrent with a data session channel, between the ASR and the mobile station.

48. The system according to claim 45, wherein keywords as recognized in voice commands from the end user are provided to the proxy server, and in that the proxy server comprises matching means for matching recognized voice commands with stored key elements, for finding the relevant link on which to send a request to the Application Service Provider, and in that the requested content, upon reception in the proxy server, is parsed, analyzed and pushed to the user agent.

49. The system according to claim 39, wherein for synchronization between the user agent of the mobile station and the proxy server, a client semaphore object is introduced, by the proxy server, into the original content of which the original copy is stored in said server, and activated when voice browsed content is to be pushed to be mobile station.

50. The system according to claim 49, wherein the client semaphore object is periodically updated with the value of the semaphore object in the proxy server.

51. The system according to claim 50, wherein, in the user agent, a script downloaded with original content continuously checks the client semaphore object to establish if a content refresh is required and in the proxy server, a script is used to activate the proxy semaphore object.

52. The system according to claim 50, wherein the client semaphore object is created using a WML script variable, fetched from the proxy server, and, in the proxy server, a first and a second version of said script is stored, the first version comprising a script for semaphore activation, the second version comprising a script indicating semaphore inactive.

53. A method for providing concurrent multi-modal access of global data communication networks from a dual mode mobile station, comprising the steps of:
providing a proxy server with functionality for voice browsing;
defining rules for keyword extraction from a browsed content and keywords/key elements;
indicating the keywords in the original content;
based on said indication of keywords, end user selection of a keyword to select a specific hyperlink such that arbitrary web content can be accessed by voice without requiring conversion of the original content.

54. A method for providing concurrent multi-modal access of Internet content from a dual mode mobile station, said method comprising the steps of:
providing an enhanced functionality proxy server supporting voice browsing;
establishing a connection between the enhanced proxy server and a telephony platform with an Automatic Speech Register (ASR);
defining key elements to use for voice browsing;
determining if voice browsing is to be active and, if so, performing the steps of:
setting up a voice channel between the mobile station and the Automatic Speech Register;
forwarding a request to the concerned application service provider;
parsing content and analyzing paragraphs in the content to find key elements;
modifying, in the enhanced proxy, the content by changing tag attributes to make key elements identifiable to the user;
sending the modified content to the mobile station;
opening a voice browsing session;
opening a voice channel concurrent with a data session channel;
matching, in the enhanced proxy server, keywords recognized in a user voice command with predefined and selected keywords to establish which link to use for sending a get request to the relevant application service provider; and,
processing and pushing the content received from the application service provider to the user agent.
